(19) United States
(12) Patent Application Publication
(10) Pub. No.: US 2018/0139992 A1
(43) Pub. Date: May 24, 2018

(54) METHOD FOR PRODUCING A RAW PIECE OF RECONSTITUTED MEAT AND A RAW PIECE OF RECONSTITUTED MEAT COMBINED ACCORDING TO THE METHOD

(71) Applicant: Reiner HAUF, Wien (AT)

(72) Inventor: Reiner HAUF, Wien (AT)

(21) Appl. No.: 15/573,486

(22) PCT Filed: May 11, 2016
(86) PCT No.: PCT/DE2016/100215

§ 371 Date: Jan. 25, 2018

(30) Foreign Application Priority Data
May 11, 2015 (DE) 10 2015 107 344.7

(51) Int. Cl. A23L 13/50; A23L 13/40; A23L 13/00; A23P 20/20; A23K 20/105; A23K 20/147; A23K 10/20; A23K 50/40

(52) U.S. Cl. CPC A23L 13/52; A23L 13/428; A23L 13/424; A23L 13/03; A23K 50/40; A23K 20/105; A23K 20/147; A23K 10/20; A23P 20/20

(57) ABSTRACT

The invention relates to a method for producing a raw piece of reconstituted meat and to a raw piece of reconstituted meat combined according to the method. Many known reconstituted meat products are rejected because they contain chemical additives such as aminases; they are expensive to produce, because the meat first is reconstituted and stabilized and is then preserved; and reconstituted meat combinations often have an inhomogeneous appearance and may tend to separate out their constituents. In order to overcome these disadvantages, a reconstituted meat composition contains only glycerol and salt as the binders, is stabilized and preserved by drying in a single step in a method for producing a raw piece of reconstituted meat and provides a combined raw piece of reconstituted meat the main constituents of which contain only meat ingredients from animal origin, it has the appearance of pure meat, and has a similar elasticity and a precise residual juice content.

### TECHNICAL FIELD

The present invention relates to a method for producing a reconstituted raw piece of meat and a combined raw piece of reconstituted meat/meat, more particularly a raw piece of meat for animal feed, as claimed in the generic portion of the independent claims. Reconstituted meat compositions are established for use as raw masses for reconstitutable meat products such as, for example, boiled sausages or pressed pulp. Such general mixtures are described, for example, in DD204 837 A1. Raw pieces of meat for animal feed composed of pure meat that is preserved with salt and adjusted with polyols such as glycerol to a specified residual moisture and juiciness have been known for some time.

### DESCRIPTION OF THE PRIOR ART

Generic reconstituted meat compositions contain a binder. For this purpose, DE 69737580 T2 proposes established mixtures with transglutaminase as a protein binder. WO 87/06432 A1 additionally proposes the use of humectants for adjusting the juiciness of reconstituted meat compositions to suitable levels.

A drawback of established mixtures with such binders is that in the market, the term “transglutaminase” is associated with “chemistry,” thus making it virtually impossible to overcome the accompanying negative reaction of the customer. Such “formed meat” products are described, for example, in WO 2012/045003 A2. In this case, granulates and fine pieces of meat are reconstituted into a new, visually uniform spatial form and firmly bound to one another. The drawback of such composite products is that they do not have the same organoleptic properties as those of pure, solid meat, with the result that raw pieces of meat of this type for animal feed are rejected or consumed only in small amounts by animals with a sharp sense of smell and taste.

A further drawback is that although transglutaminases allow favorable binding of the parts in a reconstituted piece, they do not allow the piece to be preserved or stabilized. Corresponding processing methods always provide for two steps, specifically reconstituting and structural stabilizing of a reconstituted raw piece of meat followed by preservation or stabilizing thereof.

A further drawback is that available reconstituted meat products have the optical appearance of sausage products of an unknown type that have been shredded to the finest degree possible; reconstituted meat products having a structure similar to that of finely shredded bologna or Gelbwurst pork and veal sausage are generally considered in the market and by customers to be products of inferior value. In this connection, US 20120237648 A1 proposes the method of irregular shredding of extruded reconstituted meat masses using a special device and providing them with flavorings and grill patterns in order to give the impression of hand-made foods. However, this does not overcome the drawback that the homogeneous cut surfaces of the finely shredded reconstituted mass continue to give the impression of meat products of uncertain composition. This gives rise to the problem of overcoming the corresponding prejudice in order to influence the buying behavior of the end consumer by means of factual information on ingredients as an objective decision-making aid. For this purpose, the inventors propose the process explained below and the reconstituted piece of meat made available by this process, which by means of an optically visible meat surface allows the general acceptance of the customer resulting from this design property.

The purpose of the present invention is therefore to overcome the drawbacks of the prior art and to provide reconstituted meat products which allow acceptance despite containing a portion of finely and very finely shredded meat containing binders.

This object is achieved according to the features of the independent claims by means of a method for producing a reconstituted raw piece of meat and a combined raw piece of reconstituted meat/meat, more particularly a raw piece of meat for animal feed. Advantageous embodiments are described in the dependent claims and in the description below.

### SUMMARY OF THE INVENTION

A method according to the invention for producing a reconstituted raw piece of meat with increased shelf life is characterized in that a reconstituted meat composition according to the invention is applied to a target surface with a uniform layer thickness and dried. In this case, a solid piece of meat is first cut into slices, the slices are arranged lying flat, and each of the slices lying flat provides an individual target surface for a reconstituted meat layer. Furthermore, the reconstituted meat composition for reconstitutable raw masses comprising shredded meat and binders is characterized by comprising the following components: 100 parts by weight of shredded animal meat, 0.1 to 20 parts by weight of salt, 0.01 to 10 parts by weight of binders composed of one or a plurality of chemically unmodified polyalcohols, 0 to 10 parts by weight of additional protein—preferably plant or animal protein—, and up to 2 parts by weight of adjusting and auxiliary substances and unavoidable accompanying substances of the components.

A combined raw piece of reconstituted meat/meat obtained by the method according to the invention is characterized in that the meat and shredded meat are composed of poultry meat.

A raw piece of animal meat according to the invention has a layer of a reconstituted meat composition comprising shredded meat and binders, wherein in turn the reconstituted meat composition consists of the components
20 to 90 parts by weight of shredded meat,
0.001 to 20 parts by weight of sodium chloride,
0.01 to 10 parts by weight of glycerol,
0 to 10 parts by weight of plant or animal protein, and
up to 2 parts by weight of adjusting and auxiliary substances and unavoidable accompanying substances of the components, the raw piece of reconstituted meat/meat further comprises a slice of solid meat, wherein in turn
the shredded meat and solid meat are composed of slaughtered meat,
the layer thickness of the reconstituted meat layer is 0.1 cm to 2 cm and the thickness of the slices is 0.1 cm to 1 cm, wherein the thickness of the slices is a maximum of 70% of the layer thickness of the reconstituted meat layer,
in the raw piece of reconstituted meat/meat, the slice of solid meat is arranged with its upper side visible, and
the raw piece of reconstituted meat/meat was obtained by preparation of the meat layers, combining them with a suitable punched out reconstituted meat layer, and drying.

### DESCRIPTION OF THE INVENTION AND ADVANTAGEOUS FEATURES

The reconstituted meat composition for reconstitutable raw masses, comprising shredded meat and binders, is characterized by comprising the components
100 parts by weight of shredded animal meat,
0.1 to 20 parts by weight of salt,
0.01 to 10 parts by weight of binders composed of one or a plurality of chemically unmodified polyalcohols,
0 to 10 parts by weight of additional protein, preferably plant or animal protein, and
up to 5 parts by weight of adjusting and auxiliary substances and unavoidable accompanying substances of the components.

In contrast to the established prior art, polyalcohols without additional modification are used. The polyalcohol used is preferably glycerol, a naturally occurring compound. A composition containing glycerol, which is taken as part of homeopathic drugs in aqueous formulations for boosting health and is known to the user from this application, is accepted by the customer in a correspondingly positive manner, thus preventing the rejection otherwise associated with the ingredient transglutaminase.

Within the meaning of the present description, “meat” refers to all tissues that can be derived from livestock and are consumable by the target group. Similar animal types are preferably selected for the various components of a composition so that the consumer can be advantageously informed in direct and concise fashion on the ingredients of the product using a generic term such as “poultry” or “beef.” It is particularly preferable in the case of animal feed products to use all of the tissue types of a prey animal species, preferably in physiologically suitable concentrations, in order to imitate as closely as possible the natural diet of a carnivorous animal to be fed: in this manner, all of the food components of the corresponding prey animal, such as, for example, the meat, skin, fatty tissue, tendons, cartilage, and innards can be offered in a product in an advantageous combination.

Within the meaning of the present invention, slaughtered meat refers to the meat of warm-blooded animals that have been killed and/or slaughtered for the purpose of food production. In this case, the use of solid muscle meat with attached and/or incorporated fatty and connective tissue, which is perceived by the consumer to be of higher quality, is preferred.

“Adjusting and auxiliary substances and unavoidable accompanying substances” refers to additives and accompanying substances that are common and/or unavoidable as the remainder of a reconstituted meat composition. In many markets, for example, additional final surface disinfection of meat products with a liquid disinfectant is mandatory. Such additives do not alter the nutrient content of a product and are usually contained in a concentration of 1 to 2% or less.

Adjusting substances adjust the properties of a food, and include, for example, UV protective agents or gas-tight container materials that seal a product toward the outside. These substances also do not alter the appearance or nutrient content of a product and are usually added in concentrations of 1 to 2% or less.

Auxiliary substances help to affect product-relevant characteristics such as color, consistency, pore size, taste, and even elasticity; although such substances improve appearance, taste, and customer acceptance, they do not significantly alter the nutrient content and are usually contained in concentrations of 1 to 2% or less.

Finally, unavoidable accompanying substances are trace and vestigial substances that are naturally contained as a result of production in the main components and adjusting and auxiliary substances. A classic example of this are the established indications regarding potential content of nut and soy proteins, which can unintentionally penetrate from parallel production lines via the air in the parts per thousand range into a product produced in parallel. Such trace and vestigial substances are typical in industrial production and are taken into account in the explained description.

Such a “remainder” thus refers to the total amount of common, unavoidable accompanying substances in industrial or commercial production of a food and includes such accompanying substances in a concentration of a few percent, preferably less than 2%, and particularly preferably less than 1%.

As a salt, sodium chloride alone should preferably be used, which unlike established salts such as phosphates or nitrates cannot cause any chemical reactions in the product and/or in the digestive tract. In combination, glycerol and salt provide a particular advantage in that in the production phase, the salt dehydrates the edges of the meat segments to a certain extent—in the case of sodium chloride, particularly advantageously, without any chemical redox reaction—while the glycerol retains a portion of the meat juice extracted in this manner and thus ensures juiciness of the raw mass in the form of residual moisture even in the case of excessively lengthy drying times.

A method according to the invention for producing a reconstituted raw piece of meat with increased shelf life is characterized in that a reconstituted meat composition according to the invention
is placed on a target surface having a uniform layer thickness and
dried.

In contrast to the prior art, stabilizing of the shape and preservation preferably take place in a single step, which reduces costs, and in combination with glycerol, provides in a particularly advantageous manner preserved products having an adjustable degree of residual moisture of the meat juice and a precise degree of juiciness.

According to the invention, a method is used for producing a raw piece of reconstituted meat/meat in which
a solid piece of meat is first cut into slices, and
the slices are arranged lying flat, wherein
each of the slices lying flat provides an individual target surface for a reconstituted meat layer.

The meat slice arranged with its outer side visible clearly shows the origin and nature of the processed food; in this case, meat types of the same animal species are therefore preferably processed into a raw piece of reconstituted meat/meat in order to make it possible to optically convey the type of product in a clearer and more definite manner.

The method is preferably characterized in that the layer thickness of the reconstituted meat composition is 0.1 cm to 2 cm, the thickness of the slices is 0.1 cm to 1 cm, and the thickness of the slices is a maximum of 70% of the layer thickness of the reconstituted meat layer. In this manner, multiple portions of the same size and having the same nutritional value can be obtained from a piece of pure meat. Particularly preferably, this makes it possible to obtain from a chicken or poultry fillet about 10 to 20 fillets with a reconstituted meat layer adjacent to their undersides.

In this manner, a combined raw piece of reconstituted meat/meat is preferably obtained wherein the meat and shredded meat are composed of poultry, particularly preferably chicken or poultry meat.

The combined raw piece of reconstituted meat/meat is preferably characterized in that the slice of solid meat is arranged therein with its upper side visible, and a laterally enclosing edge ensures an optically uniform transition to the reconstituted meat layer bonded by drying on the underside. This allows a product to be obtained that ensures a highly acceptable appearance as a patty, animal feed, or an animal snack. For animals or consumers requiring higher protein content, animal or plant protein can be optionally added. Particularly preferably, animal protein is used that was obtained from the same animal species used for the shredded meat and the meat slices. Using glycerol as a polyalcohol, the above-described reconstituted meat composition can be advantageously dried to preserve it or can be particularly effectively bonded to the meat slice: the inventors take as a point of departure that the salt, a portion of which is in direct contact with the meat slice, will dehydrate the slice in planar fashion, and that glycerol will penetrate into the meat slice at least at the edges thereof in the area of the contact surface between the reconstituted meat layer and the meat slice. This can suitably explain why the raw piece of reconstituted meat/meat made available in this manner can be bent and deformed like a pure piece of dried meat without the slice becoming detached from the layer.

Further advantages can be seen from the examples. The preferred features and advantages described above and the following examples are not to be understood as limitative. Advantageous or preferred additional features and additional combinations of features, as specified in the description, can be implemented in the claimed subject matter either individually or in combination within the scope of the independent claims without deviating from the scope of patent protection.

### DETAILED DESCRIPTION OF THE INVENTION BY MEANS OF EXAMPLES

In a preferred embodiment, a combined raw piece of reconstituted meat/meat, more particularly a raw piece of meat for animal feed, comprises a layer of a reconstituted meat composition comprising shredded meat and binders, wherein in turn the reconstituted meat composition consists of the components
20 to 90 parts by weight of shredded meat,
0.001 to 20 parts by weight of sodium chloride,
0.01 to 10 parts by weight of glycerol, and
0 to 10 parts by weight of animal or plant protein,
with the remainder comprising adjusting and auxiliary substances and unavoidable accompanying substances of the components, the raw piece of reconstituted meat/meat further comprises at least one slice of solid meat, wherein in turn
the shredded meat and slice of solid meat are composed of chicken or poultry meat,
the layer thickness of the reconstituted meat layer is 0.1 cm to 2 cm, the thickness of the slices is 0.1 cm to 1 cm, and the thickness of the slices is a maximum of 70% of the layer thickness of the reconstituted meat layer,
in the raw piece of reconstituted meat/meat, the at least one slice of solid meat is arranged with its outer side visible, and
the raw piece of reconstituted meat/meat was obtained by preparing the meat slices, combining them with a suitably punched out reconstituted meat layer, optionally applying further slices, and drying.

In a further advantageous embodiment, solid muscle meat, preferably from an outer chicken fillet, is first cut into longitudinal slices measuring 2.5 mm. For this purpose, the meat is prepared by chilling or freezing in order to ensure improved uniformity of the slices produced at 3±5° C. from the partially solidified tissue. The layer fillet obtained in this manner is composed of approximately 15 to 20 oval slices of identical thickness up to ±0.1 mm with varying diameters. These slices are placed on a conveyor belt.

In parallel to this process, the reconstituted meat is produced according to a predetermined recipe; for this purpose, mechanically obtained poultry tissue having the lowest possible fat content, which because of its content of tendons and cartilage can provide better texture, is preferably used. Frozen blocks of such meat are shredded and then finely minced for 5 minutes with a small amount of salt, preferably 0.002%, and 7% glycerol relative to the mixture. The temperature of the minced mixture is constantly maintained at less than −3° C. Optimum juiciness and reconstitutability are obtained at −3 to −5° C. The mass temperature-controlled in this manner is passed through a reconstituting machine in which the suitable reconstituted fillet pieces are produced.

For this purpose, the fillet slices are analyzed, suitable oval shapes are chosen from a selection of 16 available shapes, and formed reconstituted meat layers are punched out. The shapes are selected so that they correspond to sizes less than or equal to the oval slices of the fillets. The reconstituted meat layers are fed onto a parallel conveyor belt, and the fillet slices are placed on the respective reconstituted meat layers, wherein the individual layer diameters correspond at a maximum to the diameter of the slice; the fillet and/or the reconstituted meat layer is preferably turned such that there is a maximum number of contact points at the edges of the reconstituted meat layer that has been kept smaller or of equal size.

The reconstituted meat/meat product produced in this manner is dried at approximately 50 to 80° C. in a hot-air oven for approx. 18-24 hours to a residual moisture of approx. 10%. In the finished preferred product, both layers are bonded to each other in a stable manner and show no tendency to separate, even when subjected to impact, pressure, or shock stresses in a loosely stacked bag package.

### INDUSTRIAL APPLICABILITY

A method is proposed for producing a reconstituted raw piece of meat and a combined raw piece of reconstituted meat/meat.

Many reconstituted meat products have been rejected as disadvantageous because: they contain chemical additives such as aminases; they are expensive to produce, because the meat must first be reconstituted and stabilized and is then preserved; and reconstituted meat/meat combinations often have an inhomogeneous appearance and may tend to separate out their components.

As a solution, a reconstituted meat composition is proposed for the first time that contains only glycerol and salt as binders. Moreover, a method is proposed for producing a reconstituted raw piece of meat in which stabilizing and preservation are carried out in a single step by drying. Finally, a combined raw piece of reconstituted meat/meat is proposed, the main components of which contain only meat ingredients of animal origin, which has the optical appearance of pure meat, has a similar elasticity and a precisely adjustable residual juice content, and can be more simply and economically obtained by means of the method.

Such a raw piece can be utilized as food, particularly preferably as pet food; in the latter case, the reconstituted meat in this combination is particularly advantageous in that despite having the optical appearance of a pure fillet, it can include all types of meat from prey animals and therefore much better corresponds to the natural diet of a carnivorous pet.

1. A method for producing a reconstituted raw piece of meat with increased shelf life, wherein a reconstituted meat composition
is applied to a target surface with a uniform layer thickness and
dried, wherein the reconstituted meat composition for reconstitutable raw masses, comprising shredded meat and binders, consists of the components
100 parts by weight of shredded animal meat,
0.1 to 20 parts by weight of salt,
0.01 to 10 parts by weight of binders composed of one or a plurality of chemically unmodified polyalcohols,
0 to 10 parts by weight of additional protein, preferably plant or animal protein, and
up to 5 parts by weight of adjusting and auxiliary substances and unavoidable accompanying substances of the components, characterized in that for producing a raw piece of reconstituted meat/meat,
a solid piece of meat is first cut into slices, and
the slices are arranged lying flat, wherein
each of the slices lying flat provides an individual target surface for a reconstituted meat layer.

2. The method as claimed in claim 1, characterized in that only sodium chloride is used as a salt.

3. The method as claimed in claim 1, characterized in that only glycerol is used as a binder.

4. The method as claimed in claim 1, characterized in that the layer thickness of the reconstituted meat composition is 0.1 cm to 2 cm, the thickness of the slices is 0.1 cm to 1 cm, and the thickness of the slices is a maximum of 70% of the layer thickness of the reconstituted meat layer.

5. The method as claimed in claim 1, characterized in that a combined raw piece of reconstituted meat/meat as claimed in one of the preceding claims is produced, and characterized in that only poultry meat is used as meat and shredded meat.

6. The method as claimed in claim 1, characterized in that only chicken or poultry meat is used as meat and as shredded meat.

7. The method as claimed in claim 1, characterized in that in the raw piece of reconstituted meat/meat, the slice of solid meat is arranged with its upper side visible and with a lateral surrounding edge, with the edge thus ensuring an optically uniform transition to the reconstituted meat layer bonded on its underside by drying.

8. A combined raw piece of reconstituted meat/meat obtained as claimed in claim 1, more particularly a raw piece of animal feed, comprising
a layer of a reconstituted meat composition containing shredded meat and binders, wherein in turn the reconstituted meat composition comprises the components
at least 110 parts by weight of shredded meat,
0.001 to 20 parts by weight of sodium chloride,
0.01 to 10 parts by weight of glycerol, and
0 to 10 parts by weight of plant or animal protein,
with the remainder comprising adjusting and auxiliary substances and unavoidable accompanying substances of the components,
the raw piece of reconstituted meat/meat further comprises a slice of solid meat, wherein in turn
the shredded meat and solid meat are composed of slaughtered meat,
the layer thickness of the reconstituted meat layer is 0.1 cm to 2 cm, the thickness of the slices is 0.1 cm to 1 cm, and the thickness of the slices is a maximum of 70% of the layer thickness of the reconstituted meat layer,
in the raw piece of reconstituted meat/meat, the slice of solid meat is arranged with its upper side visible, and
the raw piece of reconstituted meat/meat was obtained by preparation of the meat layers, combining them with a suitably punched out reconstituted meat layer, and drying.
